(19) United States
(12) Patent Application Publication
(10) Pub. No.: US 2026/0306969 A1
(43) Pub. Date: Oct. 8, 2026

(54) DEVICES, SYSTEMS, AND METHODS TO MANAGE AN EMULSION IN A FLUID COLLECTION AND TRANSPORTATION SYSTEM

(71) Applicant: Schlumberger Technology Corporation, Sugar Land, TX (US)

(72) Inventor: Clare Schoene, Houston, TX (US)

(21) Appl. No.: 19/172,020

(22) Filed: Apr. 7, 2025

(51) Int. Cl. B01D 17/12; B01D 17/04

(52) U.S. Cl. CPC B01D 17/12; B01D 17/047

(57) ABSTRACT

An emulsion management system may apply a physics model to a fluid collection and transportation system having a fluid flow passing therethrough. An emulsion management system may identify a total shear exposure for the fluid collection and transportation system. An emulsion management system may use the total shear exposure, adjusting at least one operating parameter of the fluid collection and transportation system.

### BACKGROUND OF THE DISCLOSURE

Hydrocarbon fluids produced from a wellbore includes a combination of oil, water, and natural gas. Prior to refining, the fluid is produced at the wellbore, collected, and transported to a processing facility. At the processing facility, the fluid may be at least partially separated into its constituent parts. But during production, collection, and transportation, the fluids may form a water/oil emulsion. Breaking the emulsion may include chemicals, energy, and time.

### SUMMARY

In some aspects, the techniques described herein relate to a method for emulsion management. An emulsion management system applies a physics model to a fluid collection and transportation system having a fluid flow passing therethrough. The emulsion management system identifies a total shear exposure for the fluid collection and transportation system. Using the total shear exposure, the emulsion management system adjusts at least one operating parameter of the fluid collection and transportation system.

In some aspects, the techniques described herein relate to a method for emulsion management. An emulsion management system measures a plurality of fluid properties of a fluid flow at a plurality of locations of a fluid collection and transportation system. The emulsion management system inputs the plurality of fluid properties at the plurality of locations into a fluid model of the fluid collection and transportation system. The fluid model outputs a shear exposure for the fluid collection and transportation system. The emulsion management system applies a machine learning model to the shear exposure. The machine learning model is trained to output an emulsion breaking rating based on input shear exposure. Based on the emulsion breaking rating, the emulsion management system adjusts at least one operating parameter of the fluid collection and transportation system.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of an emulsion management system, according to at least one embodiment of the present disclosure.

FIG. 2 is a representation of an emulsion management system, according to at least one embodiment of the present disclosure.

FIG. 3 is a flow diagram of an emulsion management system, according to at least one embodiment of the present disclosure.

FIG. 4 is a flow diagram of an emulsion management system, according to at least one embodiment of the present disclosure.

FIG. 5 is a flowchart of a method for emulsion management, according to at least one embodiment of the present disclosure.

FIG. 6 is a flowchart of a method for emulsion management, according to at least one embodiment of the present disclosure.

FIG. 7 is a representation of a computing system, according to at least one embodiment of the present disclosure.

### DETAILED DESCRIPTION

This disclosure generally relates to devices, systems, and methods for managing an emulsion formed in an oil and gas production fluid. Oil and gas production fluids may include a combination of hydrocarbon fluids (e.g., crude oil), water, gas, suspended solids, dissolved solids, and other compounds. Fluid collected from a wellsite may be collected and transported to a processing facility, at which components of the fluid, including the water, oil, gas, and other components may be separated. The resulting components may be processed prior to further refining, including refining into petroleum products, natural gas, and so forth.

In some situations, collection and transportation of the fluid may cause the oil and water in the fluid to form an emulsion. For example, various elements of a collection and transportation system may apply shear forces on the fluid. The shear forces on the fluid may emulsify the components of the fluid, including the oil and water in the fluid. Indeed, greater shear forces may result in a tighter emulsion. For example, greater shear forces may cause the emulsion droplets to be smaller and/or more closely distributed.

Separating the emulsion into its constituent parts is an involved process. For example, separating the emulsion may include adding one or more demulsifier chemicals (e.g., emulsion breakers), filtering droplets, increasing the temperature of the emulsion, or waiting for a period of time until the components naturally separate. Tighter emulsions may be more difficult to break, or may be more difficult to separate into the constituent parts. For example, tighter emulsions may use a higher amount of a demulsifier chemical, a higher temperature, or require more waiting time to break the emulsion. This may increase the costs of fluid processing.

In accordance with at least one embodiment the present disclosure, an emulsion management system may apply a fluid model to the fluid collection and transportation system. The fluid model may identify locations within the fluid collection and transportation system that apply shear stresses to the fluid. The fluid model may identify the impact of the shear stresses on the emulsion of the fluid, resulting in a shear exposure. For example, the fluid model may identify the total amount of shear stresses (e.g., the total shear exposure) applied to the fluid. The total shear exposure may then be used to determine the emulsion tightness, or to estimate a difficulty of breaking the emulsion, such as by determining an emulsion breaking rating.

The emulsion management system may, based on the emulsion breaking rating, generate a recommendation to adjust at least one aspect of the fluid collection and transportation system. For example, the emulsion management system may adjust at least one setting of the elements of the fluid collection and transportation system, such as a valve setting, a pump setting, a flow director position, and so forth. This may reduce the total shear stresses (e.g., reduce the total shear exposure) applied to the fluid. Reducing the total shear exposure of the fluid may reduce the tightness of the emulsion, thereby reducing the difficulty to break the emulsion.

As illustrated by the foregoing discussion, the present disclosure utilizes a variety of terms to describe features and advantages of the emulsion management system. Additional detail is now provided regarding the meaning of such terms. For example, as used herein, the term “machine learning” refers to algorithms that generate data-driven predictions or decisions from known input data by modeling high-level abstractions. Examples of machine-learning models include computer representations that are tunable (e.g., trainable) based on inputs to approximate unknown functions. For instance, a machine-learning model includes a model that utilizes algorithms to learn from, and make predictions on, known data by analyzing the known data to learn to generate outputs that reflect patterns and attributes of the known data. For example, machine-learning models include latent Dirichlet allocation (LDA), multi-arm bandit models, linear regression models, classification models, logistical regression models, random forest models, support vector machines (SVMs) models, neural networks (convolutional neural networks, recurrent neural networks such as LSTMs, graph neural networks, etc.), or decision tree models.

A machine learning model may be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning model may include one or multiple machine learning models that cooperatively generate one or more outputs based on corresponding inputs.

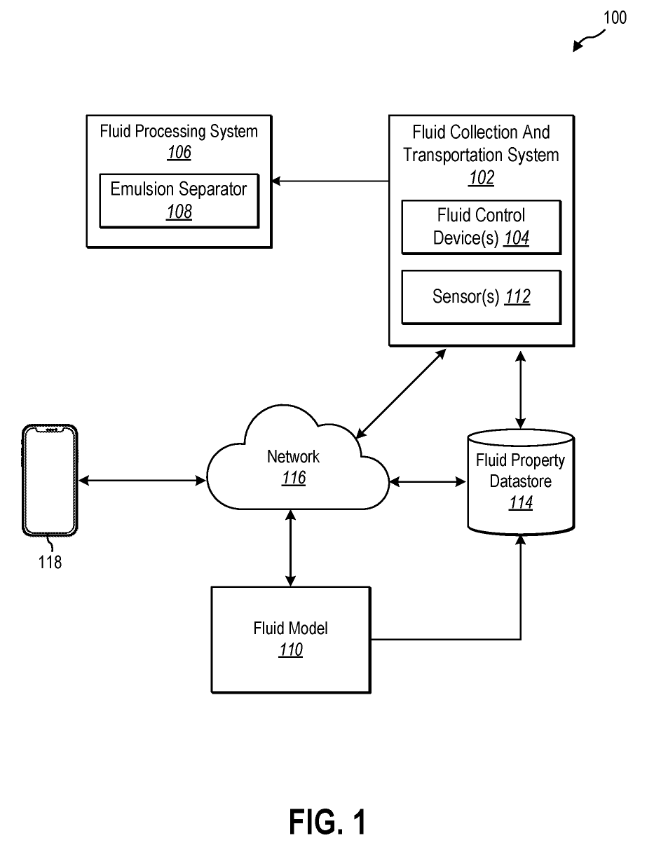

FIG. 1 is a representation of an emulsion management system 100, according to at least one embodiment of the present disclosure. The emulsion management system 100 may include a fluid collection and transportation system 102. The fluid collection and transportation system 102 may receive a fluid from a wellsite or collection system. The fluid may include a combination of one or more of oil, water, gas, solids, and other components.

The fluid collection and transportation system 102 may include one or more fluid control devices 104. The fluid control devices 104 may include any device used to collect, store, transport, or otherwise handle the fluid from receipt to a fluid processing system 106. During handling of the fluid, including collection, storage, piping, pumping, and other handling of the fluid, the fluid may form an emulsion. In an emulsion, droplets of one fluid are suspended in another, immiscible fluid. For example, water may form an emulsion with oil, in which water droplets are suspended in oil and/or oil droplets are suspended in water.

After transportation to the fluid processing system 106, the emulsified fluid may be separated in an emulsion separator 108. The emulsion separator 108 may separate the emulsion in any manner. As a specific, non-limiting example, the emulsion separator 108 may separate the emulsion through one or more of adding a chemical additive (such as a chemical demulsifier), applying heat, filtering, and waiting time for the fluids to naturally separate. The fluid processing system 106 may then separately process the separated components of the fluid.

The fluid control devices 104 may include any type of fluid control device, or any type of device used during the collection, storage, and transportation of the fluid from the wellbore to the fluid processing system 106. For example, the fluid control devices 104 may include one or more of piping, junctures, branches, elbows, valves, restrictions, expansions, diverters, accumulators, tanks, pumps, any other fluid control device, and combinations thereof. As fluid passes through or encounters the fluid control devices 104, the contact of the fluid with the fluid control devices 104 may apply shear stresses to the fluid. The shear stress on the fluid may be a representation of the amount of forces that act on a fluid in a given area. Shear stress in the fluid may cause the fluid to emulsify and/or tighten the emulsion. For example, shear stress in the fluid may reduce the size of droplets in the emulsion and/or increase the dispersion of droplets in the emulsion. This may increase the difficulty of breaking the emulsion by the emulsion separator 108, resulting in additional time and/or energy needed to break the emulsion.

In accordance with at least one embodiment of the present disclosure, the emulsion management system 100 may include a fluid model 110. The fluid model 110 may receive fluid data from the fluid collection and transportation system 102 to analyze the properties of the fluid collection and transportation system 102. For example, the fluid collection and transportation system 102 may include one or more sensors 112. The sensors 112 may measure properties of the fluid in the fluid collection and transportation system 102. The sensors 112 may measure any type of property of the fluid collection and transportation system 102, including one or more of pressure, volumetric flow rate, velocity, temperature, composition, density, viscosity, surface tension, droplet size, droplet size distribution, interfacial tension, emulsion hardness, settling time, base solids and water (BS&W), total dissolved solids (TDS), chemical additives (inhibitors), any other fluid property, and combinations thereof. In some embodiments, the fluid properties may include the fluid composition of the fluid. For example, the sensors 112 may include laboratory testing to determine the composition of the fluid, such as the water cut (e.g., the percentage of water in the fluid), the amount of dissolved natural gas, the oil composition, the gas composition, the water composition, TDS, chemical additives (inhibitors), BS&W, any other component, and combinations thereof.

In some embodiments, the sensors 112 may provide the measurements of the fluid properties and/or parameters to a fluid property datastore 114. The fluid property datastore 114 may include a record of the measured fluid properties and/or parameters. In some embodiments, the fluid property datastore 114 may be a cache, or short-term storage until the fluid model 110 retrieves the fluid properties. In some embodiments, the fluid property datastore 114 may include long-term storage, such as cloud storage or other long-term storage. In some embodiments, the fluid property datastore 114 may be located on-site at the fluid collection and transportation system 102 and/or the fluid processing system 106. In some embodiments, the fluid property datastore 114 may be remote storage, or cloud storage.

In accordance with at least one embodiment of the present disclosure, the fluid model 110 may include a model of the fluid collection and transportation system 102. The fluid model 110 may model the fluid passage through the fluid collection and transportation system 102 using the measured properties and fluid components. In some embodiments, the fluid model 110 may receive the measured fluid properties and fluid components directly from the sensors 112 or other portion of the fluid collection and transportation system 102. In some embodiments, the fluid model 110 may receive the measured fluid properties and fluid components from the fluid property datastore 114.

In some embodiments, the fluid model 110 may calculate or estimate the shear stress applied to the fluid in the fluid collection and transportation system 102. For example, the fluid model 110 may identify the total shear stress (e.g., the total shear exposure) applied to the fluid in the fluid collection and transportation system 102. The total shear exposure may be a cumulative shear stress experienced by the from when the fluid was received from the wellbore until the fluid arrives at the fluid processing system 106.

The total shear exposure may be representative or indicative of the tightness of the emulsion received by the fluid processing system 106. For example, a higher total shear exposure may be indicative of a tighter emulsion, or an emulsion that is harder to break. A lower total shear exposure may be indicative of a less tight emulsion, or an emulsion that is easier to break. The fluid model 110 may provide an indication of the difficulty of the emulsion to break. For example, the fluid model 110 may provide an emulsion breaking rating. The emulsion breaking rating may be an indication the tightness of the emulsion and/or the amount of time and/or energy that the emulsion separator 108 may utilize to break the emulsion.

In accordance with at least one embodiment of the present disclosure, the fluid model 110 may provide a recommendation to adjust the settings or operating parameters of at least one of the fluid control devices 104. Adjusting the settings or operating parameters of the fluid control devices 104 may change the total shear exposure of the fluid. For example, adjusting the settings or operating parameters of the fluid control devices 104 may reduce the total shear exposure of the fluid. In this manner, the emulsion management system 100 may manage the emulsion of the fluid, thereby reducing the energy and/or time needed to break the emulsion.

In some embodiments, the fluid model 110 may identify which of the fluid control devices 104 to adjust to reduce tightness of the emulsion. In some embodiments, the fluid model 110 may identify a new setting or position of the fluid control devices 104 to be changed. In some embodiments, the fluid model 110 may identify the contribution of a particular fluid control devices 104 to the total shear exposure. The fluid model 110 may adjust the settings or operating parameters of the fluid control devices 104 to reduce the total shear exposure of the fluid. In some embodiments, the fluid model 110 may provide the recommendation to adjust the settings or operating parameters of the fluid control devices 104 while maintaining an operation of the fluid collection and transportation system 102 to transport the fluid to the fluid processing system 106.

The elements of the emulsion management system 100 may be in communication over a network 116, such as the Internet, a local wireless network, a local wired network, or other network. In some embodiments, a user may interact with elements of the emulsion management system 100 using a user device 118, such as a smartphone, a tablet, a laptop computer, or other user device.

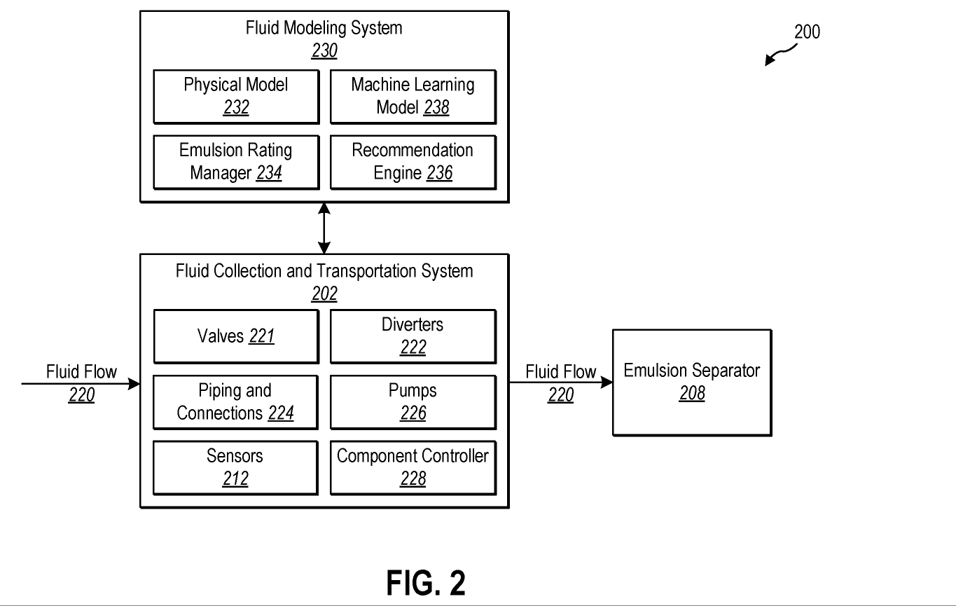

FIG. 2 is a representation of an emulsion management system 200, according to at least one embodiment of the present disclosure. Each of the components of the emulsion management system 200 can include software, hardware, or both. For example, the components can include one or more instructions stored on a computer-readable storage medium and executable by processors of one or more computing devices, such as a client device or server device. When executed by the one or more processors, the computer-executable instructions of the emulsion management system 200 can cause the computing device(s) to perform the methods described herein. Alternatively, the components can include hardware, such as a special-purpose processing device to perform a certain function or group of functions. Alternatively, the components of the emulsion management system 200 can include a combination of computer-executable instructions and hardware.

Furthermore, the components of the emulsion management system 200 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The emulsion management system 200 may include a fluid collection and transportation system 202. The fluid collection and transportation system 202 may receive a fluid flow 220. The fluid flow 220 may be a crude oil flow, such as a crude oil flow received from a wellbore or other crude oil collection system. The fluid collection and transportation system 202 may transport the fluid flow to fluid processing system, at which an emulsion separator 208 may break the emulsion by separating the fluid into water, oil, and other components.

The fluid collection and transportation system 202 may include one or more fluid control devices that may facilitate the collection and transportation of the fluid flow 220 between the wellbore and the emulsion separator 208. For example, the fluid collection and transportation system 202 may include one or more valves 221, diverters 222, piping and connections 224, pumps 226, and other fluid control devices. A component controller 228 may control the operation of the fluid control devices, or those portions of the fluid control devices that may be adjustable. For example, the component controller 228 may adjust the position of a valve 221 and/or a diverters 222, the operating setting of one or more pumps 226, or provide and adjustment to another fluid control device. Adjusting the operating parameters of the fluid control devices may adjust the volumetric flow rate of the fluid flow 220. In some embodiments, as discussed herein, adjusting the operating parameters of the fluid control devices may adjust the shear stress applied to the fluid flow 220 at the fluid control devices.

The fluid collection and transportation system 202 may include sensors 212 to monitor the status of the fluid flow 220. For example, the sensors 212 may monitor measurements of various fluid properties and/or fluid components of the fluid flow 220, as discussed herein. A fluid modeling system 230 may receive the measured or determined fluid properties and/or fluid components. The fluid modeling system 230 may apply a physics model 232 to the received fluid properties and/or fluid components. The physics model 232 may include a model of the fluid collection and transportation system 202, including a model of the various fluid control devices. In some embodiments, the physics model 232 may include the physical location and arrangement of the fluid control devices of the fluid collection and transportation system 202. The physics model 232 may model the path of the fluid flow 220 through the fluid collection and transportation system 202, including the velocity, the volumetric flow rate, the pressure, the turbulence, and so forth. In some embodiments, the physics model 232 may include or incorporate the positioning and settings, or the operating parameters, of the various fluid control devices of the fluid collection and transportation system 202. For example, the fluid collection and transportation system 202 may include the valve position of the one or more valves 221, the diverter position of the diverters 222, the piping length, shape, diameter, and junction geometry, the pump settings of the pumps 226, any other operating parameter of the fluid control devices 104 of the fluid collection and transportation system 202, and combinations thereof.

In some embodiments, the physics model 232 may model the shear stress applied to the fluid flow 220 in the fluid collection and transportation system 202. For example, the physics model 232 may model the forces applied to the fluid flow 220 and determine the shear stress based on the applied forces. In some embodiments, the physics model 232 may identify a device shear exposure associated with each of the fluid control devices. For example, the physics model 232 may identify a device shear exposure associated with the one or more valves 221, the diverters 222, the connections 224, the pumps 226, and any other fluid control devices of the fluid collection and transportation system 202. In some embodiments, the physics model 232 may identify a maximum device shear exposure for the fluid collection and transportation system 202. For example, the physics model 232 may identify the maximum device shear exposure by identifying which control device is associated with the maximum shear exposure in the fluid collection and transportation system 202. In some examples, the physics model 232 may identify a total shear exposure for the fluid collection and transportation system 202. The cumulative shear exposure may be the total shear exposure applied to the fluid flow 220 between the wellbore and the emulsion separator 208, or from the point that the fluid collection and transportation system 202 and the emulsion separator 208.

In some embodiments, the fluid modeling system 230 may include an emulsion rating manager 234. The emulsion rating manager 234 may generate an emulsion breaking rating. The emulsion breaking rating may be a representation of the difficulty of breaking the emulsion when the emulsion separator 208 receives the fluid flow 220. The emulsion rating manager 234 may generate the emulsion breaking raking based on the measured fluid properties and/or fluid components, the composition of the fluid flow 220, the operating parameters of the fluid control devices, and other elements of the fluid collection and transportation system 202.

Based on the emulsion breaking rating, a recommendation engine 236 may generate a recommendation to adjust an operating parameter of the fluid collection and transportation system 202. For example, based on the emulsion breaking rating, the recommendation engine 236 may generate a recommendation to adjust a valve position of one or more the valves 221, a diverter position of one or more of the diverters 222, a pathway of the connections 224, a pump setting of one or more of the pumps 226, adjust a chemical injection type, adjust a chemical injection rate, adjust any other operating parameter of any of any other fluid control devices, and combinations thereof.

In accordance with at least one embodiment of the present disclosure, the recommendation engine 236 may generate the recommendation by comparing the emulsion breaking rating to a threshold (e.g., an emulsion breaking rating threshold). In some embodiments, when the emulsion breaking rating is above the threshold, the recommendation engine 236 may generate the recommendation, and when the emulsion breaking rating is below the threshold, the recommendation engine 236 may not generate a recommendation.

The emulsion breaking rating may be generated or presented in any manner. For example, the emulsion breaking rating may be generated using a numerical score, a letter grade, a color code, or any other manner. The rating may be an indication of the extent of the difficulty in breaking the emulsion. In some embodiments, the recommendation to change the operating parameters may be based on the value of the emulsion breaking rating. For example, the recommendation engine 236 may prepare a recommendation to change more operating parameters and/or change the operating parameters a greater amount based on the value of the emulsion breaking rating.

In some embodiments, the recommendation engine 236 may generate the recommendation to adjust one or more operating parameters of the fluid collection and transportation system 202 based on the current fluid flow 220. For example, the recommendation engine 236 may generate the recommendation to facilitate the continued capacity of the fluid collection and transportation system 202 to handle the fluid flow 220. The recommendation engine 236 may not generate a recommendation that will prevent the fluid collection and transportation system 202 from handling the total fluid flow 220.

In some embodiments, the recommendation engine 236 may provide the recommendation to the physics model 232 to simulate the impact of the recommended changes in operating parameters on the fluid collection and transportation system 202. The physics model 232 may simulate whether the recommended changes reduces the total shear stress, whether the recommended changes reduces the overall energy expenditure (such as through a comparison between the energy spent by the emulsion separator 208 and any additional energy expenditure caused by the change in operating parameters), whether the recommended changes reduce the overall time to separate the fluid flow 220 (including any increases in transportation time at the fluid collection and transportation system 202 and any decreases in emulsion separation time at the emulsion separator 208), or otherwise models the adjusted behavior of the fluid collection and transportation system 202 based on the recommended change. If the recommended change reduces the overall time, energy, or tightness of the emulsion, the recommendation engine 236 may provide the recommendation to the fluid collection and transportation system 202 and/or an operator operating the fluid collection and transportation system 202.

While embodiments of the present disclosure discuss and/or are related to improving the ease of breaking the emulsion, it should be understood that the recommendation engine 236 may prepare a recommendation to adjust the operation of the fluid collection and transportation system 202 that results in an increase in the difficulty of breaking the emulsion. For example, the emulsion rating manager 234 may generate the emulsion breaking rating, and when the emulsion breaking rating is below a low threshold, the fluid modeling system 230 may cause changes that may improve the efficiency of the fluid collection and transportation system 202 while increasing the difficulty of breaking the emulsion at the emulsion separator 208.

In some embodiments, the recommendation engine 236 may provide the recommendation to the component controller 228 of the fluid collection and transportation system 202. The component controller 228 may adjust the operating parameters of the fluid collection and transportation system 202 based on the recommendation. For example, the component controller 228 may cause the operating position or operating parameters of the fluid collection and transportation system 202 to change to the recommended operating parameters to the recommended operating parameters. In this manner, the emulsion management system 200 may automatically mange the emulsion of the fluid flow 220, thereby reducing the difficulty of breaking the emulsion.

In some embodiments, the emulsion management system 200 may generate a feedback loop of monitoring fluid properties with the sensors 212, modeling the fluid collection and transportation system 202 with the physics model 232, generating an emulsion breaking rating with the emulsion rating manager 234, generating a recommended change with the recommendation engine 236, and adjusting the operating parameters of the fluid collection and transportation system 202 with the component controller 228. In this manner, the emulsion management system 200 may facilitate improved emulsion management, thereby reducing the difficulty of breaking the emulsion at the emulsion separator 208.

In accordance with at least one embodiment of the present disclosure, the fluid modeling system 230 may include a machine learning model 238. The machine learning model 238 may be trained on the fluid properties (e.g., an input shear exposure, input shear forces, input water cut or other fluid properties), fluid components, operating parameters of the fluid collection and transportation system 202, emulsion breaking rating, recommendations, and other elements of the emulsion management system 200. The machine learning model 238 may be trained to output emulsion breaking ratings. In some embodiments, the machine learning model 238 may be trained to output recommendations or recommended changes to the operating parameters of the fluid collection and transportation system 202. Utilizing a machine learning model 238 to facilitate the generation of emulsion breaking ratings and/or recommendations may facilitate improve accuracy and/or relevance of the emulsion breaking ratings and/or recommendations.

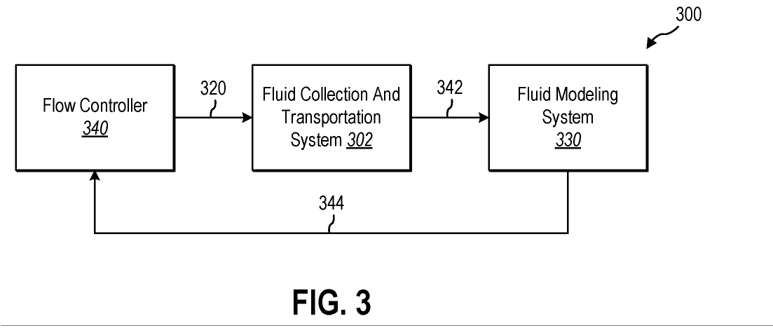

FIG. 3 is a flow diagram of an emulsion management system 300, according to at least one embodiment of the present disclosure. In the emulsion management system 300 illustrated, a flow controller 340 may control the flow of a fluid flow 320 into and through a fluid collection and transportation system 302. The flow controller 340 may control the operating parameters of one or more fluid control devices in the fluid collection and transportation system 302.

The fluid collection and transportation system 302 may provide a fluid modeling system 330 with fluid properties 342. For example, the fluid collection and transportation system 302 may include one or more sensors that may provide the fluid properties 342 to the fluid modeling system 330. The fluid modeling system 330 may, using the fluid properties 342, model the flow of the fluid flow 320 through the fluid collection and transportation system 302. In some embodiments, the fluid modeling system 330 may identify or generate an emulsion breaking rating. For example, the fluid modeling system 330 may generate the emulsion breaking rating based on the fluid properties 342 received from the fluid collection and transportation system 302.

In some embodiments, using the emulsion breaking rating, the fluid modeling system 330 may generate a recommendation 344. The recommendation 344 may include a recommendation to change one or more operating parameters of the fluid collection and transportation system 302. The fluid modeling system 330 may provide the recommendation 344 to the flow controller 340.

In some embodiments, flow controller 340 may implement the recommendation 344. For example, the flow controller 340 may provide instructions to the fluid collection and transportation system 302 to change the operating parameters of the fluid collection and transportation system 302 based on the recommendation 344 generated and provided by the fluid modeling system 330.

When the flow controller 340 implements the recommendation 344, the fluid collection and transportation system 302 may measure new fluid properties 342. The new fluid properties 342 may be provided to the fluid modeling system 330. The fluid modeling system 330 may generate a new total shear exposure, a new emulsion breaking rating and use the new emulsion breaking rating to generate a new recommendation 344. The fluid modeling system 330 may provide the new recommendation 344 to the flow controller 340, and the flow controller 340 may implement the new recommendation 344. In some embodiments, the new recommendation may include an adjustment to a different operating parameter than the initially adjusted operating parameter. In this manner, the emulsion management system 300 may form a feedback loop or a continuous control loop to control the emulsion of the fluid flow 320.

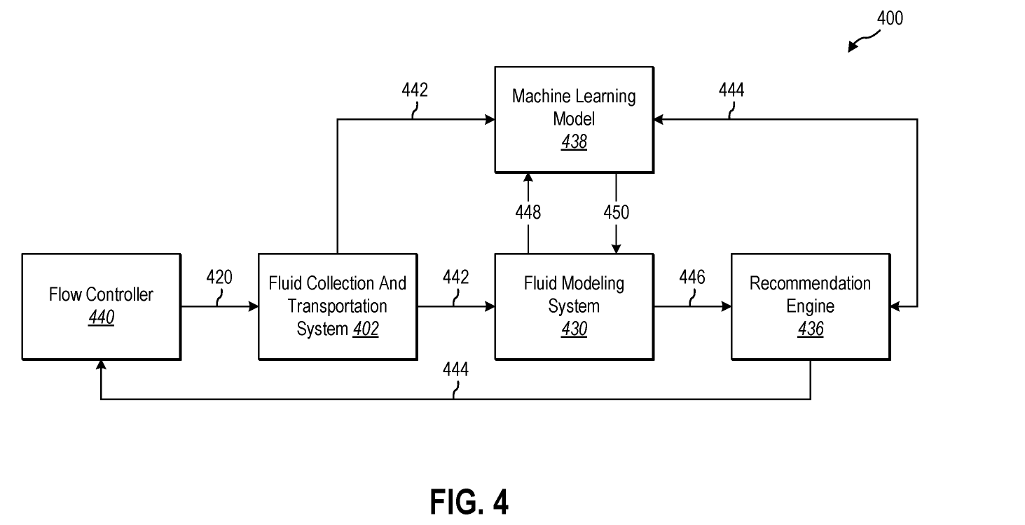

FIG. 4 is a flow diagram of an emulsion management system 400, according to at least one embodiment of the present disclosure. In the emulsion management system 400 illustrated, a flow controller 440 may control the flow of a fluid flow 420 into and through a fluid collection and transportation system 402. The flow controller 440 may control the operating parameters of one or more fluid control devices in the fluid collection and transportation system 402.

The fluid collection and transportation system 402 may collect fluid properties 442. For example, as discussed herein, the fluid collection and transportation system 402 may include one or more sensors that may measure fluid properties 442. The fluid collection and transportation system 402 may provide the fluid properties to a fluid modeling system 430. The fluid modeling system 430 may include a fluid model, such as a physics model. The physics model may model the operation of the fluid collection and transportation system 402. For example, the physics model 432 may calculate shear exposure of the fluid flow 420 in the fluid collection and transportation system 402 based on the layout of the fluid collection and transportation system 402 and the measured fluid properties 442.

The fluid modeling system 430 may, based on the shear exposure, generate an emulsion breaking rating 446. The fluid modeling system 430 may provide the emulsion breaking rating 446 to a recommendation engine 436. The recommendation engine 436, using the emulsion breaking rating 446, may generate a recommendation 444 to adjust one or more operating parameters of the fluid collection and transportation system 402. As discussed herein, the flow controller 440 may implement the recommended changes in the recommendation 444. This process may be repeated indefinitely while the fluid collection and transportation system 402 is transporting the fluid flow 420.

In accordance with at least one embodiment of the present disclosure, the emulsion management system 400 may include a machine learning model 438. The machine learning model 438 may be trained to generate an output that includes an adjustment to the fluid model, the emulsion rating model used to generate the emulsion breaking rating 446, the recommendation model from the recommendation engine 436, or other adjustment to the models of the emulsion management system 400. For example, the machine learning model 438 may receive, as an input, the fluid properties 442 from the fluid collection and transportation system 402. In some examples, the machine learning model 438 may receive, as an input, model information 448 from the fluid modeling system 430 (e.g., input shear exposure, input model properties). For example, the model information 448 may include any output from the fluid modeling system 430, including the emulsion breaking rating 446, the results of the fluid model, the total shear exposure, the shear exposure at various locations throughout the fluid collection and transportation system 402, any other model information, and combinations thereof.

The machine learning model 438 may be trained to identify correlations among the inputs, including the fluid properties 442 and the model information 448. The machine learning model 438 may generate modifications 450 to the fluid modeling system 430. For example, the machine learning model 438 may, based on the inputs, output an adjustment to the fluid model, to the weights of the emulsion breaking rating model, or other adjustment to the components of the fluid modeling system 430. In some embodiments, the machine learning model 438 may adjust the recommendations generated by the recommendation engine 436. In some embodiments, the machine learning model 438 may be trained to generate the recommendations. For example, the machine learning model 438 may identify correlations among the inputs and the impacts of changes to the fluid collection and transportation system 402 on the shear exposure based on those changes. The machine learning model 438 may be trained to output the recommendations based on the identified correlations. In this manner, the machine learning model 438 may facilitate improved analysis and recommendations, thereby improving the effectiveness of the emulsion management system 400.

In accordance with at least one embodiment of the present disclosure, an operator may validate the total shear exposure and resulting emulsion tightness calculated by the fluid modeling system 430. For example, the emulsion management system 400 may include a testing system that may test emulsified fluid flow 420 to determine the emulsion tightness of the emulsion of the fluid flow 420. The emulsion management system 400 may then validate the fluid modeling system 430 based on the tested emulsion tightness. Based on the validation of the fluid modeling system 430, the fluid modeling system 430 may adjust one or more modeling parameters of the fluid modeling system 430 based on the tested emulsion tightness.

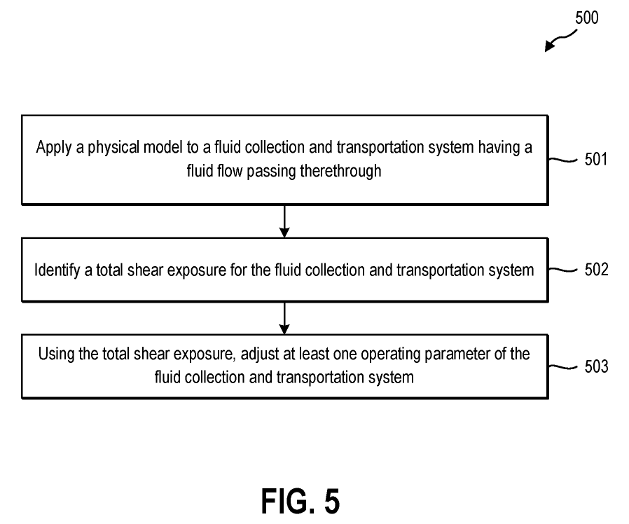

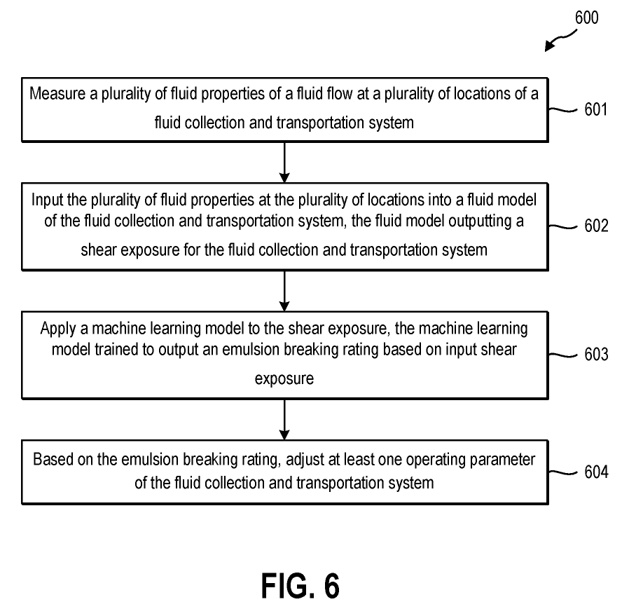

FIGS. 5 and 6, the corresponding text, and the examples provide a number of different methods, systems, devices, and computer-readable media of the emulsion management system. In addition to the foregoing, one or more embodiments can also be described in terms of flowcharts comprising acts for accomplishing a particular result, as shown in FIGS. 5 and 6. FIGS. 5 and 6 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts or a method for emulsion management, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

An emulsion management system may apply a physics model to a fluid collection system and transportation system having a fluid flow passing therethrough at 501. The emulsion management system identifies a total shear exposure for the fluid collection and transportation system at 502. Using the total shear exposure, the emulsion management system adjusts at least one operating parameter of the fluid collection and transportation system at 503.

In some embodiments, the emulsion management system may identify the shear exposure using a device shear exposure from one or more control devices of the fluid collection and transportation system. The control devices may include at least one of a valve, a restriction, a pump, a pipe, a junction, an elbow, or a diverter. The emulsion management system may identify a maximum device shear exposure and a control device of the one or more control devices associated with the maximum device shear exposure. In some embodiments, the emulsion management system adjusts the control device associated with the maximum device shear exposure.

In some embodiments, adjusting the operating parameter includes adjusting a chemical additive to the fluid collection and transportation system. In some embodiments, adjusting the additive includes adjusting any aspect of the chemical additive, such as a type of chemical additive, an amount, an injection rate, an injection location, or other aspects of the chemical additive.

In some embodiments, based on the total shear exposure, the emulsion management system may generate an emulsion breaking rating indicative of a difficulty in breaking an emulsion of the fluid flow. In some embodiments, the emulsion management system adjusts the operating parameter when the emulsion breaking rating is above a threshold. In some embodiments, the emulsion management system tests the fluid flow to determine an emulsion tightness and validates the total shear exposure based on the emulsion tightness.

In some embodiments, the total shear exposure is identified based on the composition of the fluid flow.

In some embodiments, the emulsion management system measures fluid properties of the fluid flow, and applying the physics model includes applying the physics model to the measured fluid properties. In some embodiments, the emulsion management system measures second fluid properties to generate a new total shear exposure. The emulsion management system may apply the shear model to the second fluid properties to generate a new total shear exposure and, using, the new total shear exposure, the emulsion management system further adjusts the operating parameter. In some embodiments, adjusting the operating parameter includes adjusting a different operating parameter than the previously adjusted operating parameter.

As mentioned, FIG. 6 illustrates a flowchart of a series of acts or a method for emulsion management, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

An emulsion management system measures a plurality of fluid properties of a fluid flow at a plurality of locations of a fluid collection and transportation system at 601. For example, the emulsion management system may include multiple sensors located at different locations throughout the fluid collection and transportation system. The sensors may be located at any location throughout the fluid collection and transportation system. For example, the sensors may be located at one or more of the locations of the fluid control devices. In some embodiments, the sensors may be located at inputs, outputs, easily accessible locations, or other locations in the fluid collection and transportation system.

The emulsion management system may input the plurality of fluid properties at the plurality of locations into a fluid model of the fluid collection and transportation system at 602. The fluid model outputs a shear exposure for the fluid collection and transportation system. The emulsion management system applies a machine learning model to the shear exposure at 603. The machine learning model is trained to output an emulsion breaking rating based on input shear exposure. The emulsion management system, based on the emulsion breaking rating, adjusts at least one operating parameter of the emulsion management system.

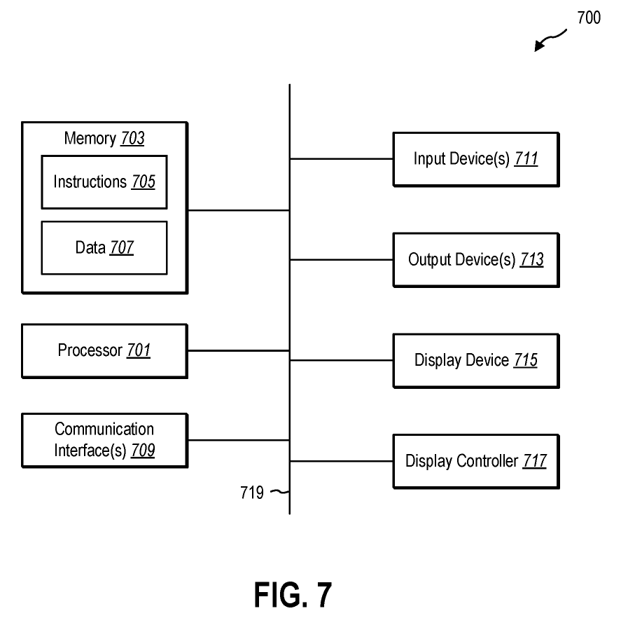

FIG. 7 illustrates certain components that may be included within a computer system 700. One or more computer systems 700 may be used to implement the various devices, components, and systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth^{®} wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for emulsion management, the method comprising:
applying a physics model to a fluid collection and transportation system having a fluid flow passing therethrough;
identifying a total shear exposure for the fluid collection and transportation system; and
using the total shear exposure, adjusting at least one operating parameter of the fluid collection and transportation system.

2. The method of claim 1, wherein identifying the total shear exposure includes identifying device shear exposure from one or more control devices of the fluid collection and transportation system.

3. The method of claim 2, wherein the one or more control devices include at least one of a valve, a restriction, a pump, a pipe, a junction, an elbow, or a diverter.

4. The method of claim 2, further comprising identifying a maximum device shear exposure and a control device of the one or more control devices associated with the maximum device shear exposure.

5. The method of claim 4, wherein adjusting at least one operating parameter includes adjusting the control device associated with the maximum device shear exposure.

6. The method of claim 1, wherein adjusting at least one operating parameter includes adjusting a chemical additive to the fluid collection and transportation system.

7. The method of claim 6, wherein adjusting the chemical additive includes adjusting an amount of the chemical additive added to the fluid collection and transportation system.

8. The method of claim 1, further comprising, based on the total shear exposure, generating an emulsion breaking rating indicative of a difficulty in breaking an emulsion of the fluid flow.

9. The method of claim 8, wherein adjusting the at least one operating parameter includes adjusting the at least one operating parameter when the emulsion breaking rating is above a threshold.

10. The method of claim 1, further comprising:
testing the fluid flow to determine an emulsion tightness; and
validating the total shear exposure based on the emulsion tightness.

11. The method of claim 1, wherein identifying the total shear exposure includes identifying the total shear exposure based on a composition of the fluid flow.

12. The method of claim 11, wherein the composition of the fluid flow includes a water cut.

13. The method of claim 1, further comprising measuring fluid properties of the fluid flow at the fluid collection and transportation system, wherein applying the physics model includes applying the physics model to the measured fluid properties.

14. The method of claim 13, wherein the fluid properties are first fluid properties, and further comprising:
measuring second fluid properties of the fluid flow;
applying the physics model to the second fluid properties to generate a new total shear exposure; and
using the new total shear exposure, further adjusting the at least one operating parameter.

15. The method of claim 14, wherein the at least one operating parameter includes a plurality of operating parameters, and wherein further adjusting the at least one operating parameter includes adjusting a different operating parameter of the plurality of operating parameters.

16. A method for emulsion management, the method comprising:
measuring a plurality of fluid properties of a fluid flow at a plurality of locations of a fluid collection and transportation system;
inputting the plurality of fluid properties at the plurality of locations into a fluid model of the fluid collection and transportation system, the fluid model outputting a shear exposure for the fluid collection and transportation system;
applying a machine learning model to the shear exposure, the machine learning model trained to output an emulsion breaking rating based on input shear exposure; and
based on the emulsion breaking rating, adjusting at least one operating parameter of the fluid collection and transportation system.

17. The method of claim 16, wherein the shear exposure includes a plurality of device shear exposures, and wherein adjusting the at least one operating parameter includes adjusting the at least one operating parameter based on the plurality of device shear exposures.

18. The method of claim 17, wherein adjusting the at least one operating parameter includes adjusting the at least one operating parameter based on a higher device shear exposure of the plurality of device shear exposures.

19. The method of claim 16, wherein applying the machine learning model to the shear exposure includes applying the machine learning model to a composition of the fluid flow.

20. A system, comprising:
a processor and memory, the memory including instructions that cause the processor to:
apply a physics model to a fluid collection and transportation system having a fluid flow passing therethrough;
identify a total shear exposure for the fluid collection and transportation system; and
using the total shear exposure, adjust at least one operating parameter of the fluid collection and transportation system.
